(19) United States
(12) Patent Application Publication
(10) Pub. No.: US 2004/0040668 A1
(43) Pub. Date: Mar. 4, 2004

(54) Holder for magnetic transfer device

(75) Inventor: Akito Kamatani, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/646,707

(22) Filed: Aug. 25, 2003

(30) Foreign Application Priority Data
Aug. 27, 2002 (JP) 246940/2002
Sep. 10, 2002 (JP) 263751/2002

(51) Int. Cl. B44C 1/00

(52) U.S. Cl. 156/540

(57) ABSTRACT

A holder for a magnetic transfer device comprising a first holder portion and a second holder portion which are movable toward and away from each other. Between the first and second holder portions, there is formed an interior space where a master carrier with information is held in intimate contact with a slave medium. At least one of the first and second holder portions has an interior pressing surface provided with an elastic member having elastic characteristics. The elastic member has a deformation quantity of 5 to 500 μm in a pressure-applied direction when pressure is applied.

### BACKGROUND OF THE INVENTION

1. Field of the Invention

The present invention relates to a holder for a magnetic transfer device that magnetically transfers information carried by a master carrier to a slave medium, and more particularly to such a holder for enclosing the master carrier and the slave medium in its interior space and bringing the master carrier into intimate contact with the slave medium.

2. Description of the Related Art

In magnetic transfer, a master carrier (patterned master) has at least a magnetic layer in which information such as servo signals is formed as a “land/groove” pattern or embedded structure, and is brought into intimate contact with a slave medium having a magnetic recording portion to which the information in the master carrier is transferred. By applying a transfer field, a magnetization pattern corresponding to the information in the master carrier is transferred and recorded on the magnetic recording portion of the slave medium. Such a magnetic transfer method is disclosed, for example, in Japanese Unexamined Patent Publication Nos. 63(1988)-183623, 10(1998)-40544, 10(1998)-269566, 7(1995)-78337 and U.S. Patent Application No. 20010028964.

In the case where the above-described slave medium is a hard disk or high-density flexible disk, one or two master carriers are brought into intimate contact with one side or both sides of the slave medium, and a transfer field is applied by a magnetic field application device, arranged on one side or both sides, which consists of electromagnets or permanent magnets.

To enhance transfer quality, it is vital to contact the master carrier and the slave medium uniformly. If they are imperfectly contacted, an area will occur in which no magnetic transfer is performed. If no magnetic transfer is performed, a signal dropout error will occur in magnetic information transferred to the slave medium and signal quantity will be degraded. In the case where recorded signals are servo signals, the tracking function cannot be sufficiently obtained and therefore reliability will be degraded. It is also extremely important that there be no dust particles on the intimate contact surface between the master carrier and the slave medium. If dust particles adhere to the intimate contact surface, intimate contact between the master carrier and the slave medium cannot be assured in an area around a dust adhering portion, so a signal dropout error will occur and signal quality will be degraded.

In the above-described magnetic transfer, from the viewpoint of obtaining uniform contact over the entire surface it is preferable that the above-described master carrier and slave medium be held in intimate contact within an interior space that is formed by two movable holder portions of a holder.

And with the master carrier and slave medium stacked within the holder at the time of magnetic transfer, external pressure is applied on the master carrier and slave medium through the holder by mechanical drive means such as an air cylinder, a servo motor, etc. In this manner, the master carrier and slave medium are brought into intimate contact with each other. In this method of applying pressure mechanically, in order to obtain uniform pressure, elastic members of the same thickness and elastic modulus are arranged in both holder portions (e.g., see the aforementioned publication No. 7(1995)-78337).

However, in the case where the above-described master carrier and slave medium are brought into intimate contact through the same elastic members arranged on both sides, the elastic members are required to have softness for bringing the master carrier and slave medium into intimate contact uniformly at uniform pressure, and hardness for performing magnetic transfer with the master carrier and slave medium contacted intimately to each other while maintaining flatness. These requirements are incompatible, and consequently, imperfect contact between the master carrier and the slave medium and positional shifts of transferred signals will result.

Since the elastic member in the above-described holder for a magnetic transfer device use extremely soft materials such as urethane foam, there are cases where at the time of intimate contact between the master carrier and the slave medium, the master carrier will move in the plane direction and therefore accuracy of alignment will be degraded.

That is, in a double-sided simultaneous transfer or single-sided transfer method (in which with respect to an elastic member installed on the interior surface of a holder portion, a master carrier is precisely positioned and held at a reference position by an image processing method, and the master carrier is brought into intimate contact with a slave medium positioned and held on another holder portion by moving the two holder portions toward each other), the extremely soft elastic member will be greatly deformed when pressure is applied, the center position of the master carrier will be shifted by the components of the deformation parallel to the intimate contact surface, the center position of the master carrier with respect to the slave medium will change, and the positional accuracy of signals recorded on the slave medium will be degraded. For instance, an allowable core shift quantity for servo signals is typically 50 to 100 μm. Therefore, if a positional shift occurs beyond this quantity, there are cases where a desired tracking function cannot be obtained.

To prevent the above-described positional shift, there is a means to use a positioning member which holds the inside diameter or outside diameter of the master carrier, but since the elastic member has a great compressive deformation when pressure is applied, the master carrier will move axially according to applied pressure and rubbing will occur between the positioning member and the master carrier. Because of this, there are cases where the life of the master carrier will be shortened due to wear, or worn particles will adhere to an intimate contact surface and degrade the quality of transferred signals.

Also, in the case of a single-sided transfer method (in which with respect to a master carrier installed on the interior surface of one holder portion, a slave medium is precisely positioned and held by an image processing method, and the reverse side of the slave medium is pressed and brought into intimate contact with the master carrier by an elastic member installed on the interior surface of another holder portion), the extremely soft elastic member will be greatly deformed when pressure is applied, the slave medium will be shifted in the planar direction, the center position of the slave medium with respect to the master carrier will change, and the positional accuracy of signals transferred to the slave medium will be degraded.

Hence, it is a first object of the present invention to provide a holder for a magnetic transfer device which is capable of enhancing intimate contact between a master carrier and a slave medium through an elastic member and enhancing the quality of transferred signals, while preventing positional shift and the occurrence of dust particles, and enhancing the durability of the master carrier.

Also, in the case where, with the above-described holder for a magnetic transfer device, double-sided simultaneous transfer is performed with both sides of the slave medium contacted intimately to master carriers, the master carriers are first held on the pressing surfaces of two holder portions. Then, the slave medium is held on the master carrier held on one holder portion. Next, by moving the two holder portions toward each other, the master carriers and the slave medium are brought into intimate contact with one another, and magnetic transfer is continuously repeated. However, when the two holder portions are separated after magnetic transfer, there are cases where the slave medium is separated not by the holder portion to which the slave medium was supplied, but by the holder portion arranged on the opposite side. That is, there are cases where the slave medium cannot be removed easily after magnetic transfer.

In the mechanism for removing the slave medium after magnetic transfer, the slave medium is removed on the assumption that the slave medium remains held after magnetic transfer by one holder portion to which the slave medium is supplied. However, after magnetic transfer, if the slave medium is held by the other holder portion, the removal mechanism cannot hold the slave medium and therefore a removal failure will occur.

Hence, it is a second object of the present invention to provide a holder for a magnetic transfer device which is capable of preventing a removal failure by holding a slave medium after magnetic transfer by a holder portion arranged on a side to which the slave medium is supplied, in double-sided simultaneous transfer.

### SUMMARY OF THE INVENTION

In accordance with the present invention, there is provided a first holder for a magnetic transfer device. The first holder of the present invention comprises a first holder portion and a second holder portion, which are movable toward and away from each other. Between the first and second holder portions, there is formed an interior space where a master carrier with information is held in intimate contact with a slave medium. At least one of the first and second holder portions has a pressing interior surface, which is provided with an elastic member having elastic characteristics. The elastic member has a deformation quantity of 5 to 500 μm in a pressure-applied direction when pressure is applied.

In the first holder of the present invention, it is preferable that the aforementioned elastic member have an elastic modulus of 5 to 200 MPa. It is desirable that the aforementioned elastic member have a press portion whose thickness fluctuation is 100 μm or less. Also, the aforementioned elastic member may have suction apertures.

It is preferable that the optimum deformation quantity of the aforementioned elastic member be greater than or equal to the total of the flatness of the interior surface of one holder portion which holds the elastic member and the flatness of the interior surface of the other holder portion. Also, the optimum elastic modulus of the elastic member is determined by primary factors such as the thickness of an elastic material to be used, a fluctuation in the thickness, precision in manufacturing the holder, pressure applied at the time of magnetic transfer, etc.

The material of the elastic member can use an elastic material such as urethane rubber, nitrile butadiene rubber (NBR), etc. If the elastic material is impregnatedwith fluorine, etc., its surface friction coefficient becomes smaller and therefore the occurrence of dust particles can be further suppressed. The elastic member is formed into a desired shape by injection molding, water jet molding, cold molding, etc.

The expression “when pressure is applied” is intended to mean “when an intimate-contact force is applied between the master carrier and the slave medium to bring them into intimate contact with each other,” and mean “the state in which at least a transfer field is applied.” The intimate-contact force is applied by a method of applying pressure mechanically, a method of applying pressure by pumping air out of the interior of the holder, a combination of both, etc. The “deformation quantity” is the quantity that the thickness of the elastic member changes before and after the application of pressure. To obtain the same deformation quantity, a thick elastic member has a high elastic modulus, and a thin elastic member has an elastic modulus lower than that. The deformation quantity is set in a range of 5 to 500 μm regardless of the thickness of an elastic member.

On the other hand, the positioning of the master carrier with respect to the holder can be performed by a method of aligning two positioning marks by processing images photographed by a CCD, etc., or a method of aligning two positioning marks by a positioning member.

There are cases where double-sided simultaneous transfer is performed with master carriers contacted intimately to both sides of a slave medium, and cases where single-sided transfer is performed with a master carrier contacted intimately to one side of a master medium and, as occasion demands, double-sided serial transfer is performed. The elastic member is installed on either or both of the opposite pressing interior surfaces of the holder. In double-sided transfer, satisfactory results were obtained by installing the elastic member on both sides when satisfactory results were not obtained by installing it on one side. In single-sided transfer, satisfactory results were obtained by installing the elastic member on one side. Also, in the case of double-sided simultaneous transfer, the elastic member is equipped with suction apertures to hold one or both master carriers, and it is preferable to suction hold the reverse side of the master carrier through the suction apertures. When the master carrier is suction held, the elastic member may also be suction held simultaneously by the holder. The elastic member may be fixedly attached to the holder by adhesion, etc. Also, the master carrier may be fixedly attached to the elastic member by adhesion, etc.

In accordance with the present invention, there is provided a second holder for a magnetic transfer device. The second holder of the present invention performs double-sided simultaneous transfer and comprises a first holder portion and a second holder portion, which are movable toward and away from each other. Between the first and second holder portions, there is formed an interior space where first and second master carriers with information are held in intimate contact with both sides of a slave medium. The first holder portion has a pressing surface on which the first master carrier and the slave medium are held, and the second holder portion has a pressing surface against which the second master carrier is pressed. When pressure is applied, the compressive deformation quantity of the pressing surface of the first holder portion is greater than that of the pressing surface of the second holder portion.

In the second holder of the present invention, the pressing surfaces of the aforementioned first and second holder portions are preferably constructed of an elastic member. In this case, the aforementioned compressive deformation quantity is adjusted by making the elastic modulus of the elastic member of the first holder portion smaller than that of the elastic member of the second holder portion, or making thickness of the elastic member of the first holder portion greater than that of the elastic member of the second holder portion, or by a combination of both.

In the second holder of the present invention, the first pressing surface of the first holder portion may be constructed of an elastic member, and the second pressing surface of the second holder portion may be constructed of a rigid body. Also, the above-described characteristics may be obtained by using different members in the first and second holder portions. When pressure is applied, the compressive deformation quantity of the pressing surface of the first holder portion is preferably 5to 50 μm and the compressive deformation quantity of the pressing surface of the second holder portion is less than 5 μm.

According to the first holder of the present invention, at least one of the first and second holder portions has a pressing interior surface, which is provided with an elastic member that applies an intimate-contact force to a master carrier and a slave medium. The elastic member has a deformation quantity of 5 to 500 μm in a pressure-applied direction when pressure is applied. Therefore, deformation of the elastic member makes it possible to intimately contact the master carrier and the slave medium uniformly over the entire surface. Moreover, the deformation quantity is as small as 500 μm and the movement of the master carrier or slave medium in the planar direction is small, so the positioning of both can be maintained with a high degree of accuracy, and the quality of transferred signals and positional precision are satisfactory.

When pressure is applied after the holder and the master carrier, or the master carrier and the slave medium, are accurately positioned by image processing means, etc., accuracy of alignment will be degraded and positional accuracy of transferred signals will be degraded, if the master carrier or slave medium moves greatly in the planar direction because of deformation of the elastic member. These problems are overcome by the present invention.

Furthermore, when pressure is applied, the deformation quantity of the elastic member is small, and in the case of using a positioning member, the occurrence of dust particles due to rubbing is small. Therefore, the degradation of the quality of transferred signals can be suppressed and a reduction in the wear on the master carrier can enhance durability thereof.

According to the second holder of the present invention, when double-sided simultaneous transfer is performed with master carriers contacted intimately to both sides of a slave medium between a first holder portion and a second holder portion which are movable toward and away from each other, the compressive deformation quantity of the pressing surface of the first holder portion when pressure is applied is greater than that of the pressing surface of the second holder portion. Therefore, the intimate-contact force between the master carrier and slave medium on the side of the first holder portion becomes higher than that between the master carrier and slave medium on the side of the second holder portion. When the first and second holder portions are separated after magnetic transfer, the slave medium is always held by the first holder portion. Therefore, the removal failure of the slave medium can be reliably prevented and the magnetic transfer process can be efficiently executed.

In addition, the pressing surface (whose compressive deformation quantity is small) of the second holder portion serves as a reference surface, whereby the flatness between the master carriers and the slave medium is assured. The pressing surface (whose compressive deformation quantity is great) of the first holder portion serves as a buffer member, whereby the master carriers andslave medium arecaused tofollow the above-described reference surface. And with the flatness between the master carriers and the slave medium maintained, the master carriers can be contacted intimately to both sides of the slave medium uniformly over the entire surface, so high positional accuracy and high quality of recorded signals on the entire slave medium are both achieved.

### BRIEF DESCRIPTION OF THE DRAWINGS

The present invention will be described in further detail with reference to the accompanying drawings wherein:

FIG. 1 is a sectional view showing the open state of a holder for a magnetic transfer device constructed in accordance with a first embodiment of the present invention;

FIG. 2 is a sectional view showing the open state of a holder for a magnetic transfer device constructed in accordance with a second embodiment of the present invention;

FIG. 3 is a sectional view showing the open state of a holder for a magnetic transfer device constructed in accordance with a third embodiment of the present invention; and

FIG. 4 is a sectional view showing the open state of a holder for a magnetic transfer device constructed in accordance with a fourth embodiment of the present invention.

### DESCRIPTION OF THE PREFERRED EMBODIMENTS

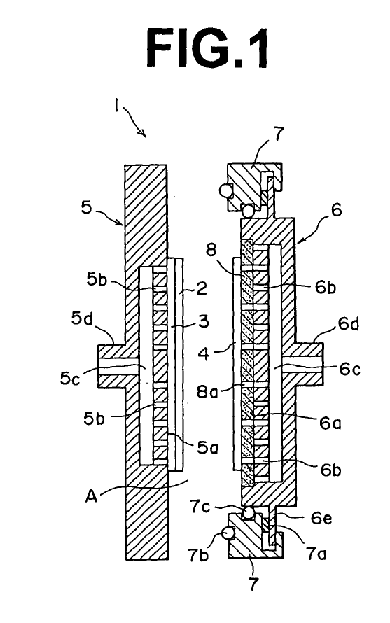

Referring to FIG. 1, there is shown a holder for a magnetic transfer device constructed in accordance with a first embodiment of the present invention. For facilitating the understanding of the present invention, the dimensions of each part are shown at ratios differing from the actual dimensions.

In the holder 1 illustrated in FIG. 1, magnetic transfer is simultaneously performed on both sides of a slave medium. The holder 1 is equipped with a left-side holder portion 5 and a right-side holder portion 6, which are movable toward and away from each other. Within an interior space A that is hermetically sealed by a seal cover 7 when the left-side and right-side holder portions 5, 6 are moved toward each other, a slave medium 2 and opposite master carriers 3, 4 are arranged, and with the centers aligned with one another, the slave medium 2 and carriers 3, 4 are held in intimate contact with one another. The expression “intimate contact” is intended to mean that they are in direct contact with one another, or that they are in close proximity to one another with an extremely slight gap.

The interior pressing surface (reference surface) 5a of the left-side holder portion 5 holds both the left-side master carrier 3, which transfers information such as servo signals to one side of the slave medium 2, and the slave medium 2. On the other hand, the interior pressing surface 6a of the right-side holder portion 6 is provided with an elastic member 8, which is in the form of a sheet and constructed of an elastic material. The elastic member 8 holds the right-side master carrier 4 that transfers information such as servo signals to the other side of the slave medium 2.

The left-side holder portion 5 is in the form of adisc, and the central portion of the circular interior pressing surface 5a, which is greater than the outside diameter of the left-side master carrier 3, has suction apertures 5b in a range corresponding to the size of the left-side master carrier 3. The suction apertures 5b communicate with an air passageway 5c, which is formed within the left-side holder portion 5. The air passageway 5c is connected to a vacuum pump (not shown) through a support shaft 5d so that the left surface of the left-side master carrier 3 can be held by suction through the introduction of suction pressure.

On the other hand, the right-side holder portion 6 is also in the form of a disc, and the interior pressing surface 6a greater than the outside diameter of the right-side master carrier 4 has a recess, which has a depth equal to the thickness of the elastic member 8. The recess is provided with a great number of suction apertures 6b. The suction apertures 6b communicate with an air passageway 6c, which is formed within the right-side holder portion 5. The air passageway 6c is connected to a vacuum pump (not shown) through a support shaft 6d. The elastic member 8 is provided with suction apertures 8a communicating with some of the suction apertures 6b formed in the recess. With this arrangement, the elastic member 8 is suction held to the interior surface 6a of the right-side holder portion 6 by part of vacuum pressure introduced into the air passageway 6c, and the right-side master carrier 4 is suction held to the surface of the elastic member 8 by the remaining vacuum pressure through the suction apertures 8a formed in the elastic member 8.

The elastic member 8 may be fixedly attached to the interior surface 6a by an adhesive instead of being suction held. Similarly, the right-side master carrier 4 may be held to the elastic member 8 by an adhesive. In this case, the formation of the apertures 8a into the elastic member 8 becomes unnecessary.

The seal cover 7 installed on the outer periphery of the right-side holder portion 6 is in the form of a ring, is mounted on a flange 6e protruding from the outer peripheral surface of the right-side holder portion 6, and is movable in the axial direction (toward and away from the left-side holder portion 5) via an elastic member 7a by the amount that the elastic member 7a is deformed. The end surface of the seal cover 7 is equipped with an end-surface seal member 7b, which consists of an O-ring and is pressed against the interior surface 5a of the left-side holder portion 5 to seal the interior space A hermetically. Also, the inner peripheral surface of the seal cover 7 is equipped with a peripheral-surface seal member 7c, which consists of an O-ring and is pressed against the outer peripheral surface of the right-side holder portion 6.

The left-side support shaft 5d and right-side support shaft 6d protrude from the centers of the back surfaces of the left-side holder portion 5 and right-side holder portion 6 and are supportedby the main body (not shown) of the magnetic transfer device. The left-side holder portion 5 and right-side holder portion 6 are connected to a drive mechanism (not shown) so that they are integrally rotated on the support shafts 5d, 6d at the time of magnetic transfer.

Although not shown, the magnetic transfer device is equipped with vacuum suction means for causing the interior space A to be in a pressure-reduced state to obtain an intimate-contact force by vacuum suctioning the interior space A, and a magnetic field application device for applying a transfer field while rotating the holder 1.

The above-described vacuum suction means maintains the interior space A of the holder 1 at a predetermined degree of vacuum so that a predetermined intimate-contact force is obtained between the slave medium 2 and master carriers 3, 4. The vacuum suction means also pumps air out of the contact surfaces between them, whereby intimate contact is enhanced.

To apply the intimate-contact force, in addition to the vacuum suction means or instead of it, the magnetic transfer device may further be equipped with press means (not shown) that applies pressure on both sides of the holder 1 mechanically. The press means may be equipped with a pressure cylinder, which has a press rod to apply a predetermined press load to the support shaft 5d or 6d of the holder 1.

At least one of the holder portions 5, 6 is movably supported in the axial direction (i.e., the right-left direction in FIG. 1) so they can move toward and away from each other. For instance, if the holder portions 5, 6 are moved from the position shown in FIG. 1 to a position where they are held in intimate contact with each other, the end-surface seal member 7b of the seal cover 7 is pressed against the interior surface 5a of the left-side holder portion 5, and the interior space A is hermetically sealed. After it is hermetically sealed, the interior space A is decompressed by the vacuum suction means (not shown), and the right-sideholder portion 6 is further pressed. This deforms the elastic member 8 and brings the master carriers 3, 4 into intimate contact with both sides of the slave medium 2 at a predetermined pressure.

The material, thickness, etc., of the elastic member 8 are determined so that when pressure is applied, the deformation quantity of the elastic member 8 in the pressure-applied direction is in a range of 5 to 500 μm.

The elastic member 8 is used to apply pressure equally, so it is formed into a discoid sheet from an elastic material. The elastic material can use urethane rubber, nitrile butadiene rubber (NBR), etc. If the elastic material is impregnated with fluorine, etc., its surface friction coefficient becomes smaller and therefore the occurrence of dust particles can be further suppressed. The elastic member 8 is formed into a desired shape by injection molding, water jet molding, cold molding, etc.

The elastic modulus (Young's modulus) of the elastic member 8 is 5 to 200 MPa. A fluctuation in the thickness of that portion of the elastic member 8 which presses the right-side master carrier 4 against the slave medium is 100 μm or less. That is, the thickness of that portion of the elastic member 8 is formed uniformly so a difference between a thick portion and a thin portion is 100 μm or less.

The optimum deformation quantity of the elastic member 8 is set so that it is greater than or equal to the total of the flatness of the interior surface 6a of the right-side holder portion 6 which holds the elastic member 8 and the flatness of the interior surface 5a of the left-side holder portion 5. The optimum elastic modulus of the elastic member 8 corresponds to the above-described deformation quantity and is determined by primary factors such as the thickness of an elastic material to be used, a fluctuation in the thickness, precision in manufacturing the holder 1, pressure applied at the time of magnetic transfer, etc.

On the other hand, the positioning of the master carriers 3, 4 and slave medium 2 with respect to the left-side holder portion 5 and right-side holder portion 6 is performed, for example, either by making fine adjustments of the master carriers 3,4 or slave medium 2 in the X and Y directions with positioning marks as reference by the use of position observation means such as a measuring microscope, a CCD camera, etc., or by installing positioning members on the holder portions 5, 6 and mounting the inside diameter of the master carriers 3, 4 or slave medium 2 on the positioning members.

Note that in addition to the elastic member 8 provided in the right-side holder portion 6, another elastic member may be provided in the interior surface 5a of the left-side holder portion 5. These elastic members are provided according to the thickness, rigidity, etc., of the slave medium 2 and master carriers 3, 4 in order to obtain higher intimate contact between the master carriers 3, 4 and the slave medium 2. Therefore, there are cases where only a single elastic member is required and cases where installing two elastic members on both sides is preferred. In the case of installing two elastic members to hold the master carriers 3, 4, the elastic members need to have suction apertures, respectively.

The slave medium 2 is constructed of a magnetic storage disk, such as a hard disk, a high-density flexible disk, etc., which has one or two magnetic recording portions (magnetic layers) on one side or both sides. The magnetic recording portion is constructed of a coat-type magnetic recording layer or metal thin film type magnetic recording layer.

The master carriers 3, 4 are formed as disks. The substrates of the master carriers 3, 4 have a microscopic land/groove pattern coated with a magnetic substance, and these inner surfaces of the master carriers 3, 4 are information carrying surfaces, having a transfer pattern, which are brought into intimate contact with both sides of the slave medium 2. On the other hand, the outer surfaces of the master carriers 3, 4 are suction held by the holder portions 5, 6. Materials for the substrates of the master carriers 3, 4 are nickel (Ni), silicon (Si), quartz, glass, aluminum, alloys, ceramics, synthetic resin, etc. The above-described land/groove pattern is formed by a stamper generation method, etc. The formation of the magnetic layer on the land/groove pattern is performed by a vacuum film forming method (such as vacuum evaporation, sputtering, ion plating, etc.), a plating method, etc. In both cases of planar recording and perpendicular recording, master carriers to be used are approximately the same.

In the case of planar recording, a magnetic field application device (not shown), for applying an initializing field and a transfer field, is constructed of ring-type head electromagnets, which have a coil wound on a core having a radial gap in the radial direction of the slave medium 2 and are arranged on both sides of the holder 1. The electromagnets arranged on both sides apply transfer fields in the same direction parallel to the data track direction, respectively. By rotating the holder 1, the transfer fields are applied to the entire surfaces of the slave medium 2 and the master carriers 3, 4. Instead of rotating the holder 1, the magnetic field application device may be rotated with respect to the holder 1. The magnetic field application device may be arranged only on one side. There may be provided one or two permanent magnet devices on one side or both sides. Also, a magnetic field application device in the case of perpendicular recording is constructed of electromagnets or permanent magnets, which are arranged on both sides of the holder 1 and differ in polarity. The magnetic field application device generates a magnetic field in a direction perpendicular to the holder 1 and applies it to the slave medium 2 and the master carriers 3, 4. In the case where a magnetic field is applied to a portion of the holder 1, the magnetic transfer to the entire surface is performed by moving either the holder 1 or the magnetic field.

Next, a description will be given of the magnetic transfer process. In the above-described holder 1, magnetic transfer is performed on a plurality of slave media 2 by the same master carriers 3, 4. Initially, the master carriers 3, 4 are positioned with respect to the left-side holder portion 5 and right-side holder portion 6 and are held by the holder portions 5, 6.

With the left-side holder portion 5 and the right-side holder portion 6 spaced, the slave medium 2 previously magnetized in the planar direction or perpendicular direction is positioned so that the center thereof is aligned with those of the master carriers 3, 4. Next, the right-side holder portion 6 is moved toward the left-side holder portion 5.

After the interior space A of the holder 1 is closed, the interior space A is decompressed by pumping air out of the space A with the vacuum suction means, and the interior is reduced to a predetermined degree of vacuum. If the right-side holder portion 6 is further moved toward the left-side holder portion 5, the master carrier 4 is brought into contact with the slave medium 2. With pressure due to an external force (atmospheric pressure) proportional to the degree of vacuum, parallel intimate-contact forces are exerted uniformly on the slave medium 2 and master carriers 3, 4 toward the left-side holder portion 5 through the elastic member 8, whereby they are brought into intimate contact with one another at a predetermined contact pressure.

Thereafter, the magnetic field application device (not shown) is moved toward both sides of the holder 1. The magnetic field application device applies transfer fields in the direction opposite to the direction of the initializing field, while rotating the holder 1. In this manner, magnetization patterns corresponding to the transfer patterns on the master carriers 3, 4 are transferred and recorded on the magnetic recording portions of both sides of the slave medium 2, respectively.

Each of the transfer fields applied during magnetic transfer is passed through the land pattern portion of the land/groove pattern (transfer pattern) of each master carrier 3 (or 4) that is in intimate contact with the slave medium 2. In the case of planar recording, the initial magnetization in the land pattern portion of the land/groove pattern is not reversed, but the initial magnetization in the groove pattern portion is reversed. In the case of perpendicular recording, the initial magnetization in the land pattern portion is reversed, but the initial magnetization in the groove pattern portion is not reversed. As a result, magnetization patterns corresponding to the transfer patterns on the master carriers 3, 4 are transferred and recorded on both sides of the slave medium 2.

According to the first embodiment, in bringing the master carriers 3, 4 into intimate contact with both sides of the slave medium 2, the right-side master carrier 4 is uniformly pressed through the elastic member 8 with an intimate-contact force created when the deformation quantity of the elastic member 8 is 5 to 500 μm. With the deformation of the elastic member 8, the contact surfaces between the slave medium 2 and the master carriers 3, 4 can be aligned with each other, and the slave medium 2 and the master carriers 3, 4 can be intimately contacted uniformly over the entire surface without forming any gap therebetween. Therefore, magnetization patterns corresponding accurately to the transfer patterns formed in the master carriers 3, 4 can be transferred and recorded on both sides of the slave medium 2. In addition, there is no excessive deformation in the elastic member 8 and therefore the shift of the master carrier 4 in the planar direction is small. Thus, since the positional shift of a transferred signal is within an allowable core shift quantity, better transfer quality due to uniform contact can be obtained and magnetic transfer with high reliability can be performed. Furthermore, even when positioning members are used, the deformation quantity of the elastic member 8 is small and therefore the quantity of the master carrier 4 to be moved in a direction where pressure is applied is small. Thus, the occurrence of dust particles and reduction in the durability due to the rubbing of the positioning members can be suppressed.

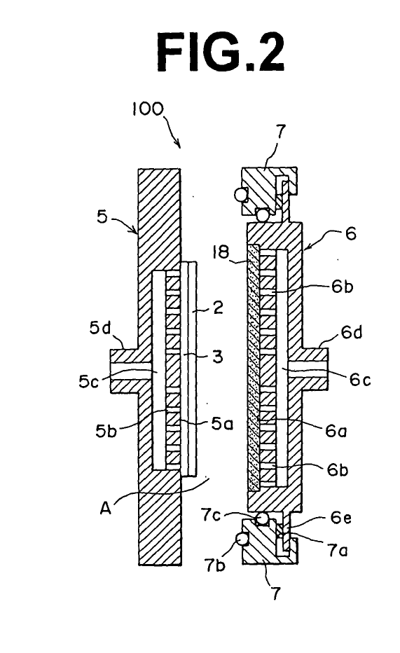

Referring to FIG. 2, there is shown a holder 100 constructed in accordance with a second embodiment of the present invention. In this embodiment, magnetic transfer is serially performed with a master carrier 3 contacted intimately to one side of a slave medium 2.

The holder 100 of the second embodiment, as with the first embodiment, is equipped with a left-side holder portion 5 and a right-side holder portion 6 which are movable toward and away from each other. Within an interior space A that is hermetically sealed by a seal cover 7 when the left-side and right-side holder portions 5, 6 are moved toward each other, the slave medium 2 and master carrier 3 are arranged, and with the centers aligned with each other, the slave medium 2 and carrier 3 are held in intimate contact with each other. In this state, magnetic transfer is performed.

The basic structure of the left-side holder portion 5 and right-side holder portion 6 is the same as the first embodiment, so a description of the same parts is omitted by applying the same reference numerals to the same parts.

The interior pressing surface (reference surface) 5a of the left-side holder portion 5 holds both the master carrier 3, which transfers information such as servo signals to one side of the slave medium 2, and the slave medium 2. On the other hand, the interior pressing surface 6a of the right-side holder portion 6 is provided with an elastic member 18, which is in the form of a sheet and constructed of an elastic material. The other side of the slave medium 2 is pressed against the elastic member 18.

Since the elastic member 18 has no suction apertures, it is suction held to the interior surface 6a by vacuum pressure introduced in air passageway 6c. Note that instead of being suction held, the elastic member 18 may be firmly attached to the interior surface 6a by an adhesive.

At least one of the holder portions 5, 6 is movable so they can move toward and away from each other. For example, if the holder portions 5, 6 are moved from the position shown in FIG. 1 to a position where they are held in intimate contact with each other, the interior space A is hermetically sealed. After it is hermetically sealed, the interior space A is decompressed by the vacuum suction means (not shown), and the right-side holder portion 6 is further pressed. This deforms the elastic member 18 and brings the master carrier 3 into intimate contact with one side of the slave medium 2 at a predetermined pressure.

The material, thickness, etc., of the elastic member 18 are determined so that when pressure is applied, the deformation quantity of the elastic member 18 in the pressure-applied direction is in a range of 5 to 500 μm.

The remaining construction is the same as the first embodiment. Next, a description will be given of operation of the holder 100 of the second embodiment. In the holder 100, magnetic transfer is performed on a plurality of slave media 2 through the same master carrier 3. The master carrier 3 is first positioned with respect to the left-side holder portion 5 and is held by the holder portion 5. Then, with the left-side holder portion 5 and the right-side holder portion 6 spaced, the slave medium 2 previously magnetized in the planar direction or perpendicular direction is positioned so that the center is aligned with that of the master carrier 3. Next, the right-side holder portion 6 is moved toward the left-side holder portion 5.

After the interior space A of the holder 100 is closed, the interior space A is decompressed by pumping air out of the space Awith the vacuum suction means, and the interior is reduced to a predetermined degree of vacuum. If the right-side holder portion 6 is further moved toward the left-side holder portion 5, the elastic member 18 is brought into contact with the slave medium 2. With pressure due to an external force (atmospheric pressure) proportional to the degree of vacuum, parallel intimate-contact forces are exerted uniformly on the slave medium 2 and master carrier 3 toward the left-side holder portion 5 through the elastic member 18, whereby they are brought into intimate contact with one another at a predetermined contact pressure. Thereafter, the magnetic field application device (not shown) performs magnetic transfer by applying a transfer field in a direction opposite to the direction of the initial magnetization.

According to the second embodiment, when the elastic member 18 is brought into intimate contact with the slave medium 2, the deformation quantity of the elastic member 18 is 5 to 500 μm. Therefore, the elastic characteristics required for uniform contact are obtained. In addition, the positional shift in the planar direction of the slave medium 2 due to excessive deformation of the elastic member 18 is small. Since the positional shift of transferred signals is within an allowable core shift quantity, better transfer quality due to uniform contact is obtained and magnetic transfer with high reliability is performed.

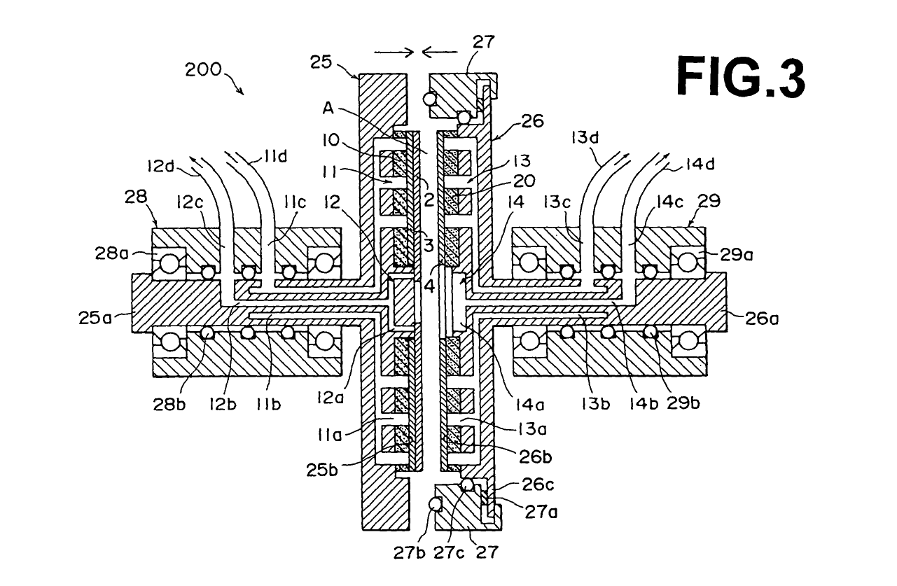

Referring to FIG. 3, there is shown a holder for a magnetic transfer device constructed in accordance with a third embodiment of the present invention.

In the case where the elastic member 8 is installed in the pressing surface 6a of the right-side holder portion 6 to enhance intimate contact, as in the first embodiment, the right-side master carrier 4 pressed through the elastic member 8 is pressed along the surface configuration of the slave medium 2 by operation of the elastic member 8. In such a case, if the intimate-contact force of the left-side holder portion 5 with respect to the slave medium 2 becomes higher, there are cases where an intimate-contact force will separate the left-side master carrier 3 from the slave medium 2. Such a problem is overcome by the third embodiment. Also, when the same elastic members are installed on both pressing surfaces, there are cases where the slave medium 2 will be transferred to the right-side holder portion 6 when the holder portions 5, 6 are separated from each other after magnetic transfer and therefore stable separation cannot be obtained. This problem is also overcome by the third embodiment.

In the holder 200 illustrated in FIG. 3, magnetic transfer is simultaneously performed on both sides of a slave medium. The holder 200 is equipped with a left-side holder portion 25 and a right-side holder portion 26, which are movable toward and away from each other. Within an interior space A that is hermetically sealed by a seal cover 27 when the left-side and right-side holder portions 25, 26 are moved toward each other, a slave medium 2 and opposite master carriers 3, 4 are arranged, and with the centers aligned with one another, the slave medium 2 and carriers 3, 4 are held in intimate contact with one another.

The left-side holder portion 25 and right-side holder portion 26 are equipped with support shafts 25a, 26a extending from the center portions of the back surfaces, respectively. The support shafts 25a, 26a are rotatably supported by a left-side fixing portion 28 and right-side fixing portion 29, respectively. The left-side fixing portion 28 has two bearings 28a and three seal members (O-rings) 28b. Similarly, the right-side fixing portion 29 has two bearings 29a and three seal members (O-rings) 29b.

The left-side holder portion 25 has a pressing surface 25b, which holds and presses the left-side master carrier 3 and slave medium 2. The pressing surface 25b is constructed of a first elastic member 10. The right-side holder portion 26 has a pressing surface 26b, which holds and presses the right-side master carrier 4. The pressing surface 26b is constructed of a second elastic member 20.

The first elastic member 10 and second elastic member 20 are formed so that when pressure is applied as described later, the compressive deformation quantity of the pressing surface 25b of the left-side holder portion 25 becomes greater than that of the pressing surface 26b of the right-side holder portion 26. For example, respective materials are selected so that the elastic modulus of the first elastic member 10 becomes smaller than that of the second elastic member 20, or the thickness of the first elastic member 10 is made greater than that of the second elastic member 20. Also, materials and thickness may be adjusted so that the above-described relation between the compressive deformation quantities is obtained.

Materials, thickness, etc., are determined so that when pressure is applied, the compressive deformation quantity of the pressing surface 25b (i.e., the first elastic member 10) of the left-side holder portion 25 is 5 to 50 μm and the compressive deformation quantity of the pressing surface 26b (i.e., thesecond elastic member 20) of the right-side holder portion 26 is less than 5 μm.

The left-side holder portion 25 is equipped with a first vacuum system 11 for suction holding the left-side master carrier 3 that transfers information such as servo signals to one side of the slave medium 2, and a second vacuum system 12 for suction holding the inner circumferential portion of the slave medium 2. The right-side holder portion 26 is equipped with a third vacuum system 13 for suction holding the right-side master carrier 4 that transfers information such as servo signals to the other side of the slave medium 2, and a fourth vacuum system 14 for decompressing an interior space A.

The vacuum systems 11 to 14 are connected from the holder portions 25 and 26, through the support shafts 25a and 25b, and to external units (not shown). That is, the left-side holder portion 25 is in the form of a disk and has the above-described first elastic member 10 on the interior surface corresponding to the size of the master carrier 3. The pressing surface 25b of the first elastic member 10 and the left-side holder portion 25 are providedwith the suction apertures 11a of the first vacuum system 11, which are in communication with a first air passageway 11b. The first air passageway 11b is installed axially into the outer peripheral portion of the support shaft 25a from the disk portion of the left-side holder portion 25, and also protrudes from the disk portion of the left-side holder portion 25 to a height corresponding to the pressing surface 25b in ring form. Also, the left-side holder portion 25 is provided with the suction aperture 12a of the second vacuum system 12 at the holder surface located outside the inside diameter of the master carrier 3. The suction aperture 12a is in communication with a second air passageway 12b, which is installed axially into the centerportion of the support shaft 25a from the disk portion of the left-side holder portion 25. The first air passageway llb and second air passageway 12b are open at different positions on the outer periphery of the support shaft 25a, and the fixing portion 28 are provided with three seal members 28b so that the first air passageway 11b and second air passageway 12b are isolated from each other. The first air passageway 11b and second air passageway 12b are in communication with communication holes 11c and 12c, which are connected to external vacuum sources or pumps (not shown) through air pipes 11d, 12d. In this manner, the first and second vacuum systems 11, 12 are connected to external vacuum pumps. If the vacuum pumps are actuated, the left side of the master carrier 3 and the inner circumferential portion of the slave medium 2 are suction held by the first vacuum system 11 and second vacuum system 12.

Note that the first elastic member 10 may be fixedly attached to the left-side holder portion 25 by an adhesive, etc. Also, by closing some of the suction apertures 11a of the first elastic member 10, the first elastic member 10 may be suction held by the first vacuum system 11.

On the other hand, the right-side holder portion 26, as with the left-side holder portion 25, is in the form of a disk and has the above-described second elastic member 20 on the interior surface corresponding to the size of the master carrier 4. The pressing surface 26b of the second elastic member 20 and the right-side holder portion 26 are provided with the suction apertures 13a of the third vacuum system 13, which are in communication with a third air passageway 13b. The third air passageway 13b is installed axially into the outer peripheral portion of the support shaft 26a from the disk portion of the right-side holder 26. Also, the holder surface of the second holder portion 26 which is inside the inside diameter of the master carrier 4 has a recess, and the center of the recess is provided with the suction aperture 14a of the fourth vacuum system 14. The suction aperture 14a is in communication with a fourth air passageway 14b, which is installed axially into the center portion of the support shaft 26a from the disk portion of the right-side holder portion 26. The third air passageway 13b and fourth air passageway 14b are open at different positions on the outer periphery of the support shaft 26a, and the fixing portion 29 are provided with three seal members 29b so that the third air passageway 13b and fourth air passageway 14b are isolated from each other. The third air passageway 13b and fourth air passageway 14b are in communication with communication holes 13c and 14c, which are connected to external vacuum sources or pumps (not shown) through air pipes 13d, 14d. In this manner, the third and fourth vacuum systems 13, 14 are connected to external vacuum pumps. If the vacuum pumps are driven, the right side of the master carrier 4 is suction held by the third vacuum system 13. Also, the interior space A is decompressed by the fourth vacuum system 14, whereby an intimate-contact force is obtained, and intimate contact is enhanced because air is pumped out of the intimate contact surface.

The seal members 28b and 29b, which are installed in the fixing portions 28 and 29, may be O-rings, magnetic fluid seals, and a combination of O-rings and magnetic fluid seals, which are mounted on the inner peripheries of the fixing portions 28, 29 or outer peripheries of the support shafts 25a, 26a. Magnetic fluid seals can present dust particles from occurring insealedportions, because no dust particle occur during sliding.

The seal cover 27 installed on the outer periphery of the right-side holder portion 26 is in the form of a ring, and as with the first embodiment, it is mounted on a flange 26c protruding from the outer peripheral surface of the right-side holder portion 26 and is movable in the axial direction (toward and away from the left-side holder portion 25) through an elastic member 27a by the amount that the elastic member 27a is deformed. The end surface of the seal cover 27 is equipped withan end-surface seal member 27b, which consists of an O-ring and is pressed against the interior surface 25b of the left-side holder portion 25 to seal an interior space A hermetically. Also, the inner peripheral surface of the seal cover 27 is equipped with a peripheral-surface seal member 27c, which consists of an O-ring and is pressed against the outer peripheral surface of the right-side holder portion 26 to seal the outer peripheral surface hermetically.

The left-side holder portion 25 and right-side holder portion 26 are connected to a drive mechanism (not shown) so they can rotate integrally on the support shafts 25a, 26a at the time of magnetic transfer. Although not shown, the magnetic transfer device is equipped with a magnetic field application device that applies a transfer field while rotating the holder 200.

At least one of the holder portions 25, 26 is movably supported in the axial direction (i.e., the right-left direction in FIG. 1) so they can move toward and away from each other. For instance, if the holder portions 25, 26 are moved from the position shown in FIG. 1 to a position where they are held in intimate contact with each other, the end-surface seal member 27b of the seal cover 27 is pressed against the end surface of the outer circumferential portion of the left-side holder portion 25, and the interior space A is hermetically sealed. After it is hermetically sealed, the interior space A is decompressed by the fourth vacuum system 14. The right-side holder portion 26 is further moved toward the left-side holder portion 25, whereby the master carriers 3, 4 are brought into intimate contact with both sides of the slave medium 2 at a predetermined pressure.

To apply the intimate-contact force, in addition to the fourth vacuum system 14, the magnetic transfer device is further equipped with press means (not shown) that applies pressure on both sides of the holder 200 mechanically. The press means may be equipped with a pressure cylinder, which has a press rod to apply a predetermined press load to the support shaft 25a or 26a of the holder 200.

When pressure is applied, the slave medium 2 held by the left-side holder portion 25 is depressed by the compressive deformation of the first elastic member 10, but the suction aperture 12a of the second vacuum system 12 is provided at a height taking the depressed quantity of the slave medium 2 into consideration, in order to prevent the slave medium 2 from strongly striking the holder surface near the suction aperture 12a.

The first elastic member 10 and second elastic member 20 are formed into a disk sheet from an elastic material. The elastic material can employ, for example, non-foaming polyurethane, nitrile butadiene rubber (NBR), hydrogenated nitrile butadiene rubber (HNBR), ethylene propylene rubber (EPM EPDM), fluoro rubber, acrylic rubber, HITOREL 3046 (tradename), HITOREL 3548 L (trade name), etc. These materials are selected in consideration of workability (precise thickness, flatness, etc.), elastic modulus capable of obtaining the above-described deformation quantity when pressure is applied, excellent wear resistance and high maintainability, occurrence of dustparticles, characteristic changes due to temperature, and so on. The first and second elastic members 10, 20 are formed into a desired shape by injection molding, water jet molding, cold molding, etc.

The remaining construction is the same as the first embodiment. Next, a description will be given of operation of the holder 200 of the third embodiment. In the holder 200, magnetic transfer is performed on a plurality of slave media 2 through the same master carriers 3, 4. Initially, the left-side master carrier 3 is positioned with respect to the left-side holder portion 25, and is held on the holder portion 25 by the first vacuum system 11. Similarly, the right-side master carrier 4 is positioned with respect to the right-side holder portion 26, and is held on the holder portion 26 by the second vacuum system 12.

With the left-side holder portion 25 and the right-side holder portion 26 spaced, the slave medium 2 previously magnetized in the planar direction or perpendicular direction is positioned so that the center is aligned with that of the master carrier 3. After the slave medium 2 and master carrier 3 are suction heldby the second vacuum system 12, the right-side holder portion 26 is moved toward the left-side holder portion 25.

After the interior space A of the holder 200 is closed, the interior space A is decompressed by pumping air out of the space A with the fourth vacuum system 14, and the interior is reduced to a predetermined degree of vacuum. If the right-side holder portion 26 is further moved toward the left-side holder portion 25, the slave medium 2 is brought into contact with the master carrier 4. With pressure due to an external force (atmospheric pressure) proportional to the degree of vacuum, and the applied pressure, parallel intimate-contact forces are exerted uniformly on the slave medium 2 and master carriers 3, 4 toward the left-side holder portion 25 through the first and second elastic members 10 and 20, whereby they are brought into intimate contact with one another at a predetermined contact pressure.

When pressure is applied, the pressing surface 26b (whose compressive deformation quantity is small) of the right-side holder portion 26 serves as a reference surface, whereby the flatness between the master carriers 3, 4 and the slave medium 2 is assured. The pressing surface 25b (i.e., the elastic member 30 whose compressive deformation quantity is great) of the left-side holder portion 25 serves as a buffer member, whereby the master carriers 3, 4 and slave medium 2 are caused to follow the above-described reference surface. And with the flatness between the master carriers 3, 4 and the slave medium 2 maintained, the master carriers 3, 4 are contacted intimately to both sides of the slave medium 2 uniformly over the entire surface.

The intimate contact between the left-side master carrier 3 and slave medium 2 in the left-side holder portion 25 is greater than that between the right-side master carrier 4 and the other side of the slave medium 2 in the right-side holder portion 26, because great deformation of the first elastic member 10 allows the master carrier 3 to make contact with one side of the slave medium 2 more accurately.

Thereafter, the magnetic field application device is moved to both sides of the holder 200, and applies transfer fields in a direction opposite to the direction of the initial magnetization. With the applied transfer fields, magnetization patterns corresponding to the transfer patterns of the master carriers 3, 4 are transferred and recorded on the magnetic recording portions of the slave medium 2.

After magnetic transfer, the left-side and right-side holder portions 25 and 26 of the holder 200 are separated to remove the slave medium 2. That is, if the operation of the fourth vacuum system 14 is stopped to raise pressure, the right-side holder portion 26 is moved away from the left-side holder portion 25. As described above, the intimate contact between the left-side master carrier 3 and the slave medium 2 is greater than that between the right-side master carrier 4 and the slave medium 2, and therefore the suction force of the left-side master carrier 3 with respect to the slave medium 2 is greater than that of the right-side master carrier 4 with respect to the slave medium 2. Because of this, the right-side master carrier 4 held by the right-side holder portion 26 is separated from the slave medium 2, and the slave medium 2 remains held by the left-side holder portion 25. Thereafter, the slave medium 2 is removed from the left-side holder portion 25 by a removing mechanism (not shown) . A new slave medium 2 is supplied and the above-described magnetic transfer is repeated.

According to the third embodiment, when pressure is applied, the compressive deformation quantity of the first elastic member 10 installed in the left-side holder portion 25 ismade greater than that of the second elastic member 20 installed in the right-side holder portion 26. Therefore, when the holder 200 is opened to remove the slave medium 2, the slave medium 2 is reliably held by the left-side holder portion 25. The removal of the slave medium 2 is reliably performed, so a reduction in the rate of operation due to a removal failure can be prevented. In addition, because of better contact between the carriers 3, 4 and the slave medium 2, magnetic transfer of high quality is continuously performed and reliability is enhanced.

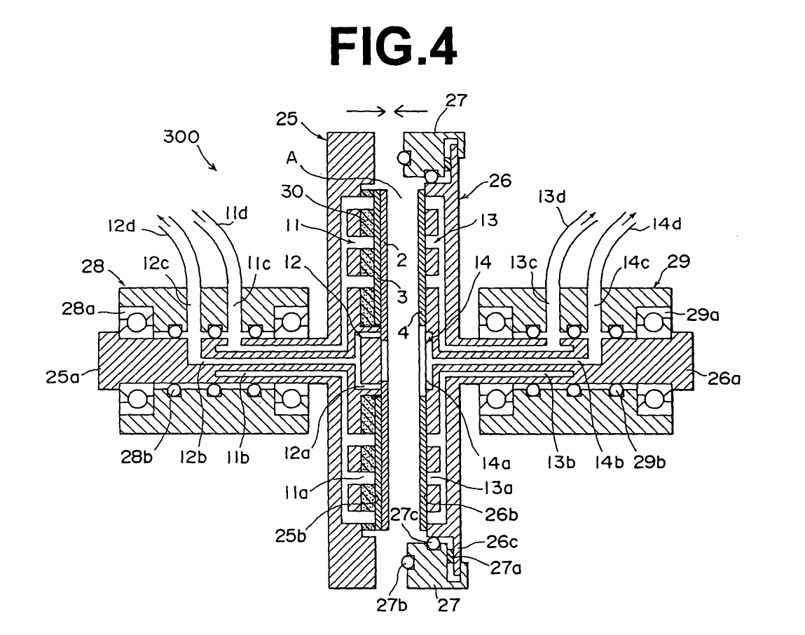

Referring to FIG. 4, there is shown aholder constructed in accordance with a fourth embodiment of the present invention. This embodiment is characterized in that an elastic member is provided only in a left-side holder portion.

The holder 300 of the fourth embodiment, as with the third embodiment, is equipped with a left-side holder portion 25 and a right-side holder portion 26 which are movable toward and away from each other. Within an interior space A that is hermetically sealed by a seal cover 27 when the left-side and right-side holder portions 25, 26 are moved toward each other, a slave medium 2 and master carriers 3, 4 are held in intimate contact with one another, and in this state, magnetic transfer is performed.

The basic structure of the left-side holder portion 25 and right-side holder portion 26 is the same as the third embodiment, so a description of the same parts is omitted by applying the same reference numerals to the same parts.

The left-side holder portion 25 is equipped with a pressing surface 25b that holds and presses the left-side master cattier 3. The pressing surface 25b is constructed of an elastic member 30. The right-side holder portion 26 is equipped with a pressing surface 26b that holds and presses the right-side master cattier 4. The pressing surface 26b is constructed of the interior surface (holder surface) of the right-side holder portion 26 and has no elastic member.

With this arrangement, when pressure is applied, the compressive deformation quantity of the pressing surface 25b (elastic member 30) of the left-side holder portion 25 becomes greater than that of the pressing surface 26b of the right-side holder portion 26. The material, thickness, etc., of the elastic member 30 are determined so that when pressure is applied, the compressive deformation quantity is 5 to 50 μm.

Note that the suction holding of the master carrier 4 in the right-side holder 26 is performed through the suction apertures 13a of a third suction system 13 formed in the pressing surface 26b. Also, the interior space A is decompressed by the suction aperture 14a of a fourth vacuum system 14 formed in the center portion of the pressing surface 26b.

The magnetic transfer process inthe fourth embodiment is performed in the same manner as the third embodiment. With the master carriers 3 and 4 held by the holder portions 25 and 26, the slave medium 2 is supplied and the interior space A is closed. By decompressing the interior space A, uniform and parallel intimate-contact forces are applied through the elastic member 30, whereby the master carriers 3, 4 are brought into intimate contact with both sides of the slave medium 2 at a predetermined contact pressure.

When pressure is applied, the pressing surface 26b (i.e., the second elastic member 20 whose compressive deformation quantity is small) of the right-side holder portion 26 serves as a reference surface, whereby the flatness between the master carriers 3, 4 and the slave medium 2 is assured. The pressing surface 25b (i.e., the first elastic member 10 whose compressive deformation quantity is great) of the left-side holder portion 25 serves as a buffer member, whereby the master carriers 3, 4 and slave medium 2 are caused to follow the above-described reference surface. Therefore, with the flatness between the master carriers 3, 4 and the slave medium 2 maintained, the master carriers 3, 4 are contacted intimately to both sides of the slave medium 2 uniformly over the entire surface.

Also, the intimate contact between the left-sidemaster carrier 3 and slave medium 2 in the left-side holder portion 25 is greater than that between the right-side master carrier 4 and slave medium 2 in the right-side holder portion 26, because deformation of the elastic member 30 allows the master carrier 3 to make contact with one side of the slave medium 2 more accurately.

And after magnetic transfer, the right-side master carrier 4 held by the right-side holder portion 26 is separated from the slave medium 2, because the intimate contact (or suction force) between the left-side master carrier 3 and slave medium 2 in the left-side holder portion 25 is greater than that between the right-side master carrier 4 and slave medium 2 in the right-side holder portion 26. When this is occurring, the slave medium 2 remains held by the left-side holder portion 25.

According to the fourth embodiment, the pressing surface 25b of the left-side holder portion 25 that holds the slave medium 2 is provided with the elastic member 30, whereby the compressive deformation quantity of the pressing surface 25b of the left-side holder portion 25 when pressure is applied becomes greater than that of the pressing surface 26b of the right-side holder portion 26. Therefore, when the holder 200 is opened to remove the slave medium 2, the slave medium 2 is reliably held by the left-side holder portion 25, so a removal failure can be prevented. In addition, because of better contact between the carriers 3, 4 and the slave medium 2, magnetic transfer of high quality is continuously performed and reliability is enhanced.

While the present invention has been described with reference to the preferred embodiments thereof, the invention is not to be limited to the details given herein, but may be modified within the scope of the invention hereinafter claimed.

What is claimed is:

1. A holder for a magnetic transfer device, comprising:
a first holder portion and a second holder portion which are movable toward and away from each other and between which there is formed an interior space where a master carrier with information is held in intimate contact with a slave medium;
wherein at least one of said first and second holder portions has an interior pressing surface provided with an elastic member having elastic characteristics;
and wherein said elastic member has a deformation quantity of 5 to 500 μm in a pressure-applied direction when pressure is applied.

2. The holder as set forth in claim 1, wherein said elastic member has an elastic modulus of 5 to 200 MPa.

3. The holder as set forth in claim 1, wherein said elastic member has a press portion whose thickness fluctuation is 100 μm or less.

4. The holder as set forth in claim 2, wherein said elastic member has a press portion whose thickness fluctuation is 100 μm or less.

5. The holder as set forth in claim 1, wherein said elastic member has suction apertures.

6. A holder for a magnetic transfer device, comprising:
a first holder portion and a second holder portion which are movable toward and away from each other and between which there is formed an interior space where first and second master carriers with information are held in intimate contact with both sides of a slave medium;
wherein said first holder portion has a pressing surface on which said first master carrier and said slave medium are held, and said second holder portion has a pressing surface against which said second master carrier is pressed;
and wherein a compressive deformation quantity of the pressing surface of said first holder portion when pressure is applied is greater than that of the pressing surface of said second holder portion.

7. The holder as set forth in claim 6, wherein the pressing surfaces of said first and second holder portions are both constructed of an elastic member.

8. The holder as set forth in claim 7, wherein the elastic member of the first holder portion has an elastic modulus smaller than that of the elastic member of the second holder portion.

9. The holder as set forth in claim 7, wherein the elastic member of the first holder portion has a thickness greater than that of the elastic member of the second holder portion.

10. The holder as set forth in claim 6, wherein the first pressing surface of said first holder portion is constructed of an elastic member, and the second pressing surface of said second holder portion is constructed of a rigid body.
